(19) United States
(12) Patent Application Publication
(10) Pub. No.: US 2013/0173226 A1
(43) Pub. Date: Jul. 4, 2013

(54) GARMENT MODELING SIMULATION SYSTEM AND PROCESS

(71) Applicants: Waymon B. Reed, Dallas, TX (US); Chris Ritchie, Austin, TX (US)

(72) Inventors: Waymon B. Reed, Dallas, TX (US); Chris Ritchie, Austin, TX (US)

(21) Appl. No.: 13/586,845

(22) Filed: Aug. 15, 2012

Related U.S. Application Data
(60) Provisional application No. 61/631,318, filed on Jan. 3, 2012.

(51) Int. Cl. G06F 17/50

(52) U.S. Cl. 703/1

(57) ABSTRACT

The present invention is directed to a system and method of simulating modeling a garment, comprising the steps of providing a dictionary having a plurality of two dimensional figure frameworks, the plurality of two dimensional figure frameworks comprising varying body characteristics and measurements, with each of the two dimensional figure frameworks comprising an image and body reference data. The system providing a garment database comprising images and pairing data for a plurality of garments. It receives a user image and a garment selection and selects a two dimensional figure framework in response to user input and garment selection. It renders a three dimensional user model from the user image and the selected two dimensional figure framework to form a user model. It overlays and scales the selected garment on the user model, whereby the user model simulates the user wearing the selected garment.

### PRIORITY

The present invention claims priority to provisional application 61/631,318, which has a filing date of Jan. 3, 2012, which is hereby incorporated by reference.

### BACKGROUND

1. Field of the Invention

The present invention relates to a simulation system, more specifically to a garment modeling simulation system.

2. Description of the Related Art

Clothing consumers seek to know how a particular garment will fit them and appear on them prior to purchase. At a physical retail location, that consumer may try on the clothing. The consumer enters a dressing room, takes off their current clothing, tries on the desired garment, observes himself or herself in a mirror, takes off the desired garment, and then put their current clothing back on. That can be tiresome, time consuming, or concerning to privacy to try on different garments at a physical location. For online clothing purchases, it is not possible to try on any particular garments. The problem of determining fit in online purchases is exacerbated by inconsistency in size definitions. A medium size of one brand may differ from the medium size of another brand.

It would be preferable to see how a garment fits and looks without having to physically try it on. Augmented reality offer possible solutions. It would be desirable to simulate a “likeness” or model of the consumer simulating him or her wearing a desired garment. However, augmented reality systems can still require substantial local computing power, special cameras, and/or travel to a physical location. For example, an augmented dressing room system to Kjaerside et al in 2005 discloses a camera, a projection surface, and visual tags. For that system, the consumer must travel to and be physically present in order to interact with that system. A second augmented dressing room system to Hauswiesner et al in 2011 discloses using a plurality of depth cameras communicately couple to a system which is used to form a model with virtual clothes. Again, that second system requires a consumer to have specialized equipment, follow a complex process, or travel to a location.

For the above reasons, it would be advantageous for a system which enables a user to employ commonly available equipment to simulate himself or herself modeling selected garments.

### SUMMARY

The present invention is directed to a system and method of simulating modeling a garment, comprising the steps of providing a dictionary having a plurality of two dimensional figure frameworks, the plurality of two dimensional figure frameworks comprising varying body characteristics and measurements, with each of the two dimensional figure frameworks comprising an image and body reference data. The system providing a garment database comprising images and pairing data for a plurality of garments. It receives a user image and a garment selection and selects a two dimensional figure framework in response to user input and garment selection. It renders a three dimensional user model from the user image and the selected two dimensional figure framework to form a user model. It overlays and scales the selected garment on the user model, whereby the user model simulates the user wearing the selected garment.

These and other features, aspects, and advantages of the invention will become better understood with reference to the following description, and accompanying drawings.

### BRIEF DESCRIPTION OF THE DRAWINGS

FIG. 1 depicts a block diagram of an embodiment of the current invention;

FIG. 2 depicts a flowchart for a process implemented to the system of FIG. 1;

FIG. 3 depicts a flowchart for the process of user model creation of FIG. 2;

FIG. 4 depicts a flowchart for the process of garment data creation of FIG. 2;

FIG. 5 depicts a flowchart for the process of garment modeling simulation of FIG. 2.

FIG. 6 depicts a series of two dimensional figure frameworks; and

FIG. 7 depicts a stage of the output of FIG. 5.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

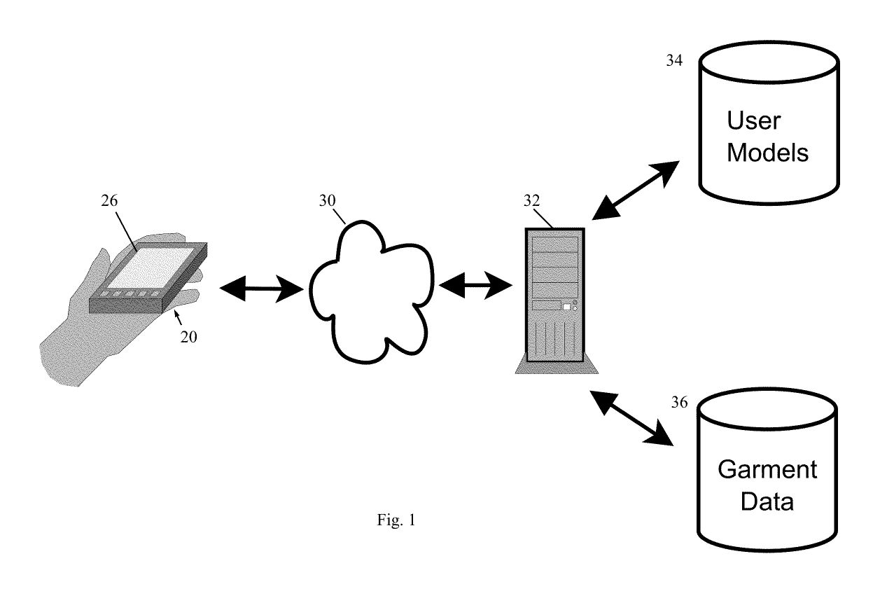

The present invention is directed to a system and process for approximated three dimensional (3D) simulation of a user modeling a garment based on two dimensional images of both the user and the garment. FIG. 1 depicts a block diagram of an embodiment of the system in operation. It depicts a handheld computer 20 with an integrated camera 22, a communication network 30, a server 32, a user model database 34, and a garment database 36. In use, the user 08 records an image with the camera 22 which is transmitted to the server 32 via the network 30. The server 32 processes the transmitted image and stores the processed image in the user model database 34. The server augments the image with a selected garment from the garment database 36 and renders a user model for display and interaction on the video screen 24 of the computer 20.

A computer 20 or server 32, as referred to in this specification, generally refers to a system which includes a central processing unit (CPU), memory, a screen, a network interface, and input/output (I/O) components connected by way of a data bus. The I/O components may include for example, a mouse, keyboard, buttons, or a touchscreen. The network interface enables data communications with the computer network 40. A server contains various server software programs and preferably contains application server software. The preferred computer 20 is a portable handheld computer, smartphone, or tablet computer, such as an iPhone, iPod Touch, iPad, Blackberry, or Android based device. The computer is preferably configured with a touch screen 26 and integrated camera 22 elements. Those skilled in the art will appreciate that the computer 20 or servers 32 can take a variety of configurations, including personal computers, hand-held devices, multi-processor systems, microprocessor-based electronics, network PCs, minicomputers, mainframe computers, and the like. Additionally, the computer 20 or servers 32 may be part of a distributed computer environment where tasks are performed by local and remote processing devices that are linked. Although shown as separate devices, one skilled in the art can understand that the structure of and functionality associated with the aforementioned elements can be optionally partially or completely incorporated within one or the other, such as within one or more processors.

Camera 22 is preferably a color digital camera integrated with the handheld computer 20.

The communication network 30 includes a computer network and a telephone system. The communication network 30 includes of a variety of network components and protocols known in the art which enable computers to communicate. The computer network may be a local area network or wide area network such as the internet. The network may include modem lines, high speed dedicated lines, packet switches, etc. The network protocols used may include those known in the art such as UDP, TCP, IP, IPX, or the like. Additional communication protocols may be used to facilitate communication over the computer network 30, such as the published HTTP protocol used on the world wide web or other application protocols.

The user model database includes base two dimensional (2D) figure frameworks and stored user models, which are composites of user images joined with one or more base 2D figure frameworks, as will be disclosed further in the specification. The base 2D figure frameworks are a plurality of system created frameworks, each framework representing a major portion or all of the human body. In the current embodiment, each framework represents the human body below the neck. The base 2D figures frameworks are of varying body measurements and characteristics. That is to say the base 2D figures are generated with a relative height, weight, body type, chest measurement, band measurement, waist measurement, hip measurement, inseam, rise, thigh measurement, arm length, sleeve length, upper arm measurement, skin tone, eye color, hair color, hair length, and other characteristics. The user model database 34 also stores user information such as pant size, shirt size, or dress size. The user model database 34 includes sufficient base 2D figure frameworks to form a dictionary of frameworks of differing body measurements and characteristics to represent cross-sections of the population. In one aspect, the system 10 divides the chest measurement into simulated one inch ranges. Each chest measurement range is paired with a given category or range of other characteristics. Thus, one 2D figure framework may represent, for example, a 42 inch chest measurement, a first given waist measurement or range, a first given given hip measurement or range, and so on for the other characteristics. The 2D figure framework dictionary is completed by varying the options for the 2D figure frameworks while maintaining one static value for the isolated characteristic in order to represent sufficient cross-sections of the population.

For each 2D figure framework, a set of body reference coordinates is stored. The body reference coordinates map a particular location or set of locations within the 2D figure framework. The body reference coordinates can define one or more regions of the body or body parts. For example, the body reference coordinates may map to the waistline region.

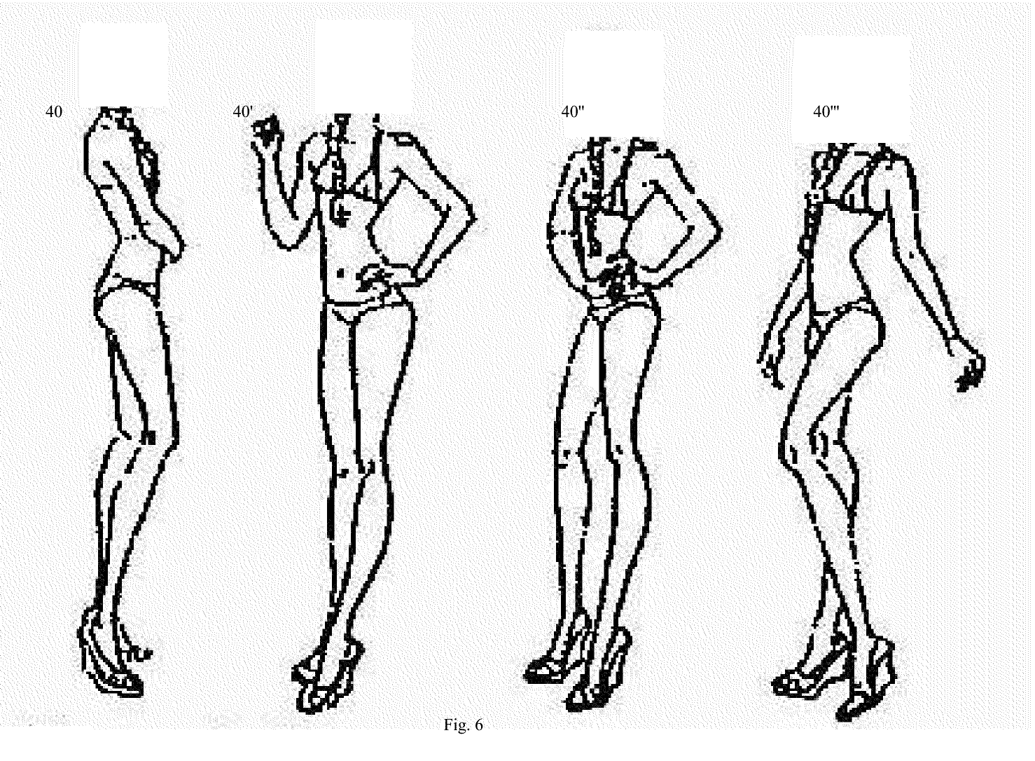

Further, each 2D figure framework may include an associated set of images for a given framework for a particular set of body measurements and characteristics. FIG. 6 depicts a series of associated set of representative frameworks 40 40′ 40″ 40′ for a particular set of body measurements and characteristics. Each of the images 40 40′ 40″ 40′ shows the particular set of body measurements and characteristics from a different vantage point or in different positions, postures, or “poses.”

The garment database 36 includes data for a plurality of garments. The garment data includes, but is not limited to, the garment type, color, pattern, size, images, and region reference coordinates. Each garment entry represents a specific article of clothing that a user may virtually model. The garment type is input. For example, a bra, a shirt, pants, dress, coat, or other article of clothing may be selected. Additionally, at least one associated image is input into the garment entry. Preferably multiple images from different vantage points are input and associated with the garment type. Each garment image has associated pairing data. The pairing data includes data which signals that a region of a particular garment should be associated with a region of the body. By way of example with a bra, the coordinates representing the lower edge of a bra may be associated with the band, or inframammary fold. Likewise, the coordinates representing the lower edge of a shirt may be associated with the hip line.

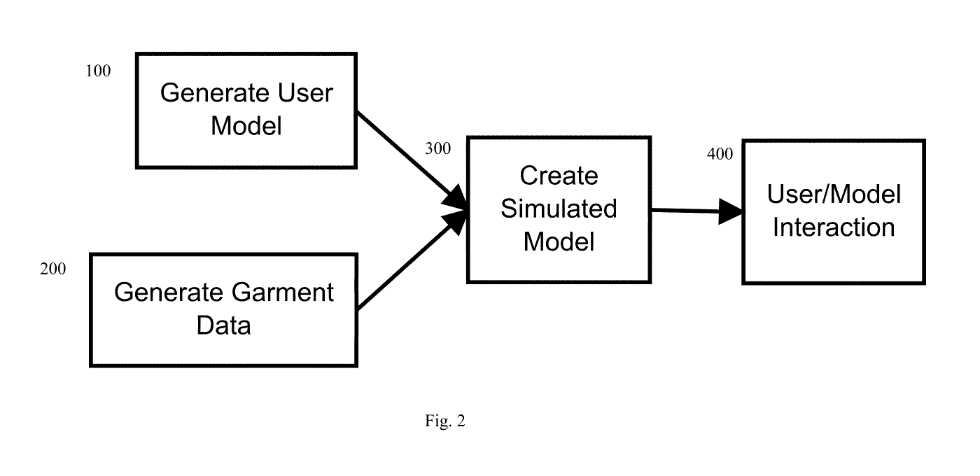

FIG. 2 shows an embodiment of the process implemented to the system of FIG. 1. The user model is generated 100. Using input garment data 200, the system generates a simulated model 300, with which the user may interact 400.

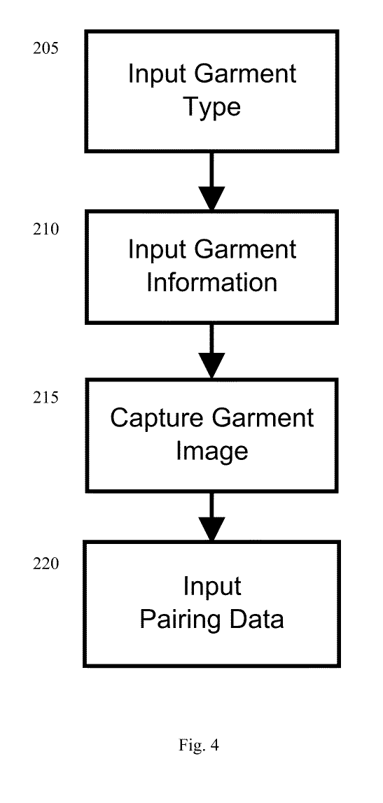

Referring to FIG. 4, garment data is input 200. At step 205, the garment type is input. Auxiliary associated garment data, such as a product identifier, size, color, is input 210. Next, one or more images of the garment are uploaded 215. The preferred vantage point of the garment images is from the front of the garment, with supplemental images from the sides and rear of the garment. The garment's information is stored in the garment database 36.

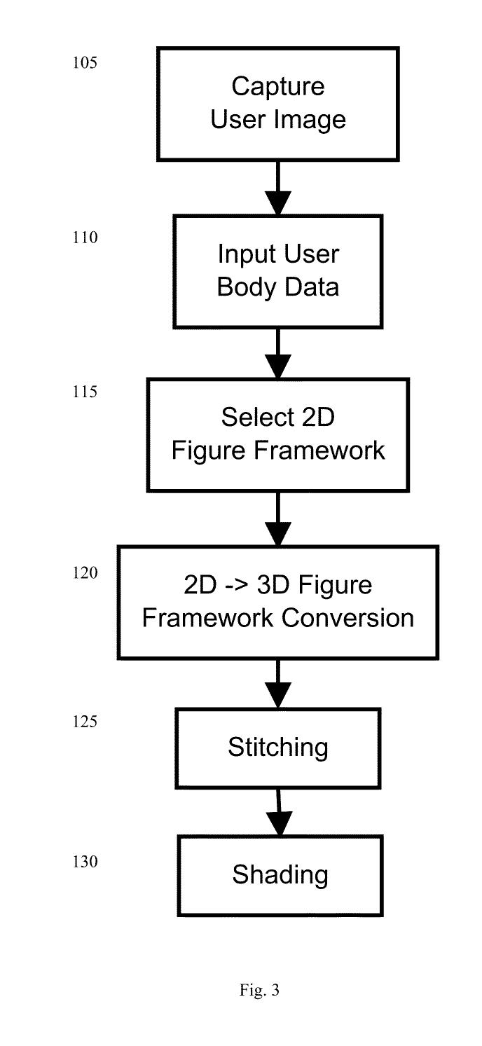

Referring to FIG. 3, the user captures an image of a portion of himself or herself 105, preferably, the upper body, more specifically above the shoulders. In the current embodiment, the system extracts the facial portion of the image, removing the background using systems and processes known in the art. Representative systems and processes include U.S. Pat. Nos. 6,611,613 to Kang et al., 7,123,754 to Matsuo et al., 6,885,760 to Yamada et al, which are incorporated by reference. The preferred vantage point is from the front of the user. The user may supplement the input with additional images from different vantage points. The system 10 stores the user images in the user model database 34.

At step 110, the system 10 presents an interface to the user. The user can input characteristics, such as height, weight, chest measurement, waist measurement, hip measurement, inseam, sleeve length, skin tone, eye color, hair color, and clothing sizes. The interface may also present simplified or derived options to the user. For example, the system may present “banana”, “apple”, “pear”, “hourglass”, or “athletic” or as “body type” options. This signals the system to apply certain body characteristics, such as certain bust-hip ratios, waist-hip ratios, or torso length to leg length ratios. The user information is stored as a profile in the user model database 34.

At step 115, the system 10 selects a 2D figure framework based upon the user input. As mentioned, the user model data database 34 includes a dictionary of 2D figure framework of varying body measurements and characteristics representing different cross-sections of the population. The system 10 selects the 2D figure framework which most closely matches the user based on the user image and user profile data. In one aspect, the system compares the user's skin tone from the profile or image to the dictionary and determine those 2D figure frameworks with a high degree of correlation in skin tone. The system determines the degree of correlation to other 2D figure framework for other user inputs and information derived from user input. The system selects the 2D figure framework with the highest aggregation correlation.

Optionally, the framework selector module is configured to retrieve a 2D figure framework representative of the user having an altered weight facade. That is to say, the framework selector module can select a base 2D figure which may represent a user if that user gains or loses weight. In this optionally approach, the system selects the 2D figure framework as disclosed. Then the framework selector module combines user input with predictive weight change attributes to select a 2D figure framework. For example, people with a lower torso length to leg length ratios may have a higher tendency to initially expand at the hip in weight gain. The system preferably employs such tendencies to aid 2D figure framework selection.

After selection of the 2D figure framework 115, the 2D figure framework base is converted to a 3D figure framework by meshing and rigging 120, using those means known in the art. In one configuration, MakeHuman is employed in the meshing and Autodesk's′ Maya is employed in the rigging. Representative meshing systems and processes include U.S. Pat. Nos. 8,089,480 to Chang et al., 6,259,453 to Itoh et al., and 6,262,737 to Li et al., which are incorporated by reference. Representative rigging systems and processes include U.S. Pat. No. 8,026,917 to Rogers et al. and U.S. Pat. App. No. 20070146360 to Clatworthy, which are incorporated by reference. The user image of step 105 is stitched to the 3D figure framework 125 to form the user model. The user images and figure framework are preferably registered, calibrated, and blended in the stitching process. Finally, a shader is applied 130 to match the tones of the user image with those of the 3D figure framework. Tools of the art such as OpenGL, Direct3D, or Renderman can be employed in the shading. The rendered user model is stored in the user model database 34.

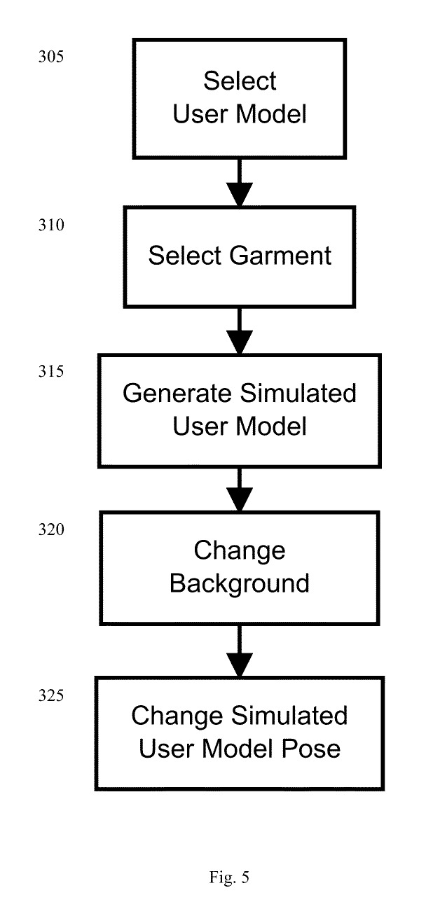

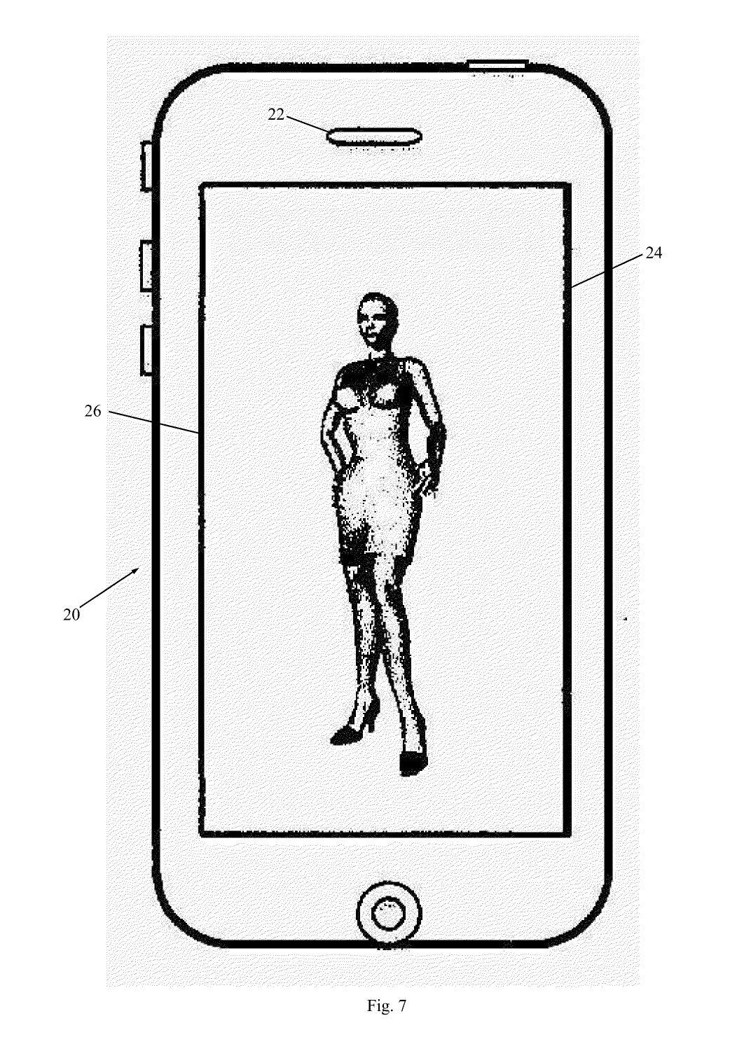

Referring to FIG. 5, the process of a user simulating modeling or “trying on” a garment is shown. First, the rendered user model is received 305. The user selects a garment 310. The system maps the garment to the user model 315, using the pairing data and body reference data to associate regions of the selected garment to regions of the user model. The user selected garment is scaled and overlaid on the user model according to the system generated user model and the user selected garment, correlating garment regions to user model regions. At step 315, the simulated model is displayed to the video screen 24, as shown in FIG. 7. The user is presented the option to change the background 320 or to change the simulated model's “pose” 325.

Insofar as the description above and the accompanying drawings disclose any additional subject matter, the inventions are not dedicated to the public and the right to file one or more applications to claim such additional inventions is reserved.

What is claimed is:

1. A method of simulating modeling a garment comprising the steps of:
providing a dictionary having a plurality of two dimensional figure frameworks, said plurality of two dimensional figure frameworks comprising varying body characteristics and measurements, each of said two dimensional figure frameworks comprising an image and body reference data;
providing a garment database comprising images and pairing data for a plurality of garments;
receiving a user image and a garment selection;
selecting a two dimensional figure framework in response to user input and garment selection;
rendering a three dimensional user model from said user image and said selected two dimensional figure framework to form a user model; and
overlaying and scaling said selected garment on said user model, whereby said user model simulates said user wearing said selected garment.

2. The process according to claim 1, wherein said two dimensional figure frameworks include the neck, torso, and legs.

3. The process of claim 1, wherein said varied characteristics and measurements of said plurality of two dimensional figure frameworks include relative weight and height.

4. The process of claim 1, wherein said varied characteristics and measurements of said plurality of two dimensional figure frameworks are selected from the following: relative weight, height, band, waist, hip, inseam, rise, thigh, arm length, sleeve length, and upper arm length.

5. The process of claim 1, wherein said user input includes weight and height.

6. The process of claim 1, wherein said user input includes pant size and shirt size.

7. The process of claim 1, wherein said user input includes options selected from the following: weight, height, band, waist, hip, inseam, rise, thigh, arm length, sleeve length, and upper arm length.

8. The process of claim 1, wherein said garment database includes a garment type and size for each garment.

9. The process of claim 1, wherein said framework selector module is configured to retrieve a two dimensional figure framework representative having an altered weight facade with respect to the user.

10. The process of claim 1, wherein said dictionary includes a series of associated images in different postures for a set of two dimensional figure frameworks of like body characteristics and measurements.

11. A system for simulating modeling a garment comprising:
a dictionary having a plurality of two dimensional figure frameworks, said plurality of two dimensional figure frameworks comprising varying body characteristics and measurements, each of said two dimensional figure frameworks comprising an image and body reference data;
a garment database comprising images and pairing data for a plurality of garments;
an interface configured to receive a user image and garment selection;
a framework selector module configured to select a two dimensional figure framework in response to user input and garment selection;
a rendering engine configured to render a three dimensional user model from said user image and said selected two dimensional figure framework to form a user model; and
said rendering engine configured to overlay and scale said selected garment on said user model, whereby said user model simulates said user wearing said selected garment.

12. The system according to claim 11, wherein said two dimensional figure frameworks comprise the neck, torso, and legs of a body.

13. The system of claim 11, wherein said varied characteristics and measurements of said plurality of two dimensional figure frameworks include relative weight and height.

14. The system of claim 11, wherein said varied characteristics and measurements of said plurality of two dimensional figure frameworks are selected from the following: relative weight, height, band, waist, hip, inseam, rise, thigh, arm length, sleeve length, and upper arm length.

15. The system of claim 11, wherein said interface includes user input for weight and height.

16. The system of claim 11, wherein said interface includes user input for pant size and shirt size.

17. The system of claim 11, wherein said interface includes user input includes options selected from the following: weight, height, band, waist, hip, inseam, rise, thigh, arm length, sleeve length, and upper arm length.

18. The system of claim 11, wherein said garment database includes a garment type and size for each garment.

19. The process of claim 11, wherein said framework selector module is configured to retrieve a two dimensional figure framework representative having an altered weight facade with respect to the user.

20. The system of claim 11, wherein said dictionary includes a series of associated images in different postures for a set of two dimensional figure frameworks of like body characteristics and measurements.

21. A system for simulating modeling a garment comprising:
a dictionary having a plurality of two dimensional figure frameworks, said plurality of two dimensional figure frameworks comprising varying body characteristics and measurements, each of said two dimensional figure frameworks comprising an image and body reference data, said two dimensional figure frameworks comprising a neck, torso, and legs;
a garment database comprising images and pairing data for a plurality of garments;
an interface configured to receive a user image and garment selection;
a framework selector module configured to select a two dimensional figure framework in response to user input and garment selection;
a rendering engine configured to extract the facial portion from said user image, render a three dimensional user model from combination of said extracted user image and said selected two dimensional figure framework to form a user model; and
said rendering engine configured to overlay and scale said selected garment on said user model, whereby said user model simulates said user wearing said selected garment.
